(19) United States
(12) Patent Application Publication
(10) Pub. No.: US 2013/0213050 A1
(43) Pub. Date: Aug. 22, 2013

(54) COMBUSTOR WITH A SINGLE LIMITED FUEL-AIR MIXING BURNER AND RECUPERATED MICRO GAS TURBINE

(71) Applicant: Micro Turbine Technology BV, (US)

(72) Inventor: Savad Shakariyants, Hertogenbosch (NL)

(73) Assignee: Miro Turbine Technology BV, Eindhoven (NL)

(21) Appl. No.: 13/848,276

(22) Filed: Mar. 21, 2013

Related U.S. Application Data
(63) Continuation of application No. PCT/NL2011/050636, filed on Sep. 20, 2011.

(30) Foreign Application Priority Data
Sep. 21, 2010 (NL) 2005381

(51) Int. Cl. F02C 3/34

(52) U.S. Cl. CPC F02C 3/34
USPC 60/774; 60/749; 60/39.511

(57) ABSTRACT

A recuperated micro gas turbine combustor has a casing, liner, fuel injector and a flame stabilization device. This flame stabilization device is characterized by a swirl strength and air passage geometry as such that the pressure loss over the device is less than 1.5%. The flame stabilization device and the fuel injector form together with the liner inlet/head hardware a single burner.

### CROSS-REFERENCE TO RELATED APPLICATIONS

This application for a utility patent is a continuation of a previously filed utility patent, now abandoned, having the application number PCT/NL2011/050636, file 20 Sep. 2011. This application for a utility patent also claims the benefit of Netherlands application NL2005381, filed 21 Sep. 2010.

### BACKGROUND OF THE INVENTION

1. Field of the Invention

The invention relates to a combustor, and more particularly to a combustor having a casing having a cylindrical wall provided with an opening for compressed air; a liner being within said casing and having a further cylindrical wall at a distance from the casing wall, an outlet opening on one end and an inlet opening on the other end; and a single burner comprising a fuel injector, flame stabilization device and the hardware of the liner inlet (liner head).

2. Description of Related Art

A combustor is known from US-A-2010/0126174. This combustor includes: a flame tube having, in the direction of the flow, a mixing zone for mixing the fuel with air to form a fuel-air mixture, as well as a primary combustion zone and a post-primary combustion zone. At least one opening is being provided in the area of the mixing zone and in the area of the post-primary combustion zone in order to conduct compressed air into the flame tube. The supplied compressed air is used to cool the flame tube and passes, via the openings in the area of the mixing zone and in the area of the post-primary combustion zone, partly into the mixing zone and into the post-primary combustion zone.

Other combustors are known from US2009019855A1, US2010000218A1, US2010071377A1, WO 0075573A1. These combustors have main burners that require assistance from pilot burners to ensure stable and complete combustion, as well as reliable light-off at all operating conditions.

Yet another combustor is known from US2002148232A1, which has multiple burners. None of the individual burners is capable to ensure adequate combustion performance at all operating conditions. Different burners, also in different combinations, have to operate at different operating conditions.

A suitable combustion chamber for a recuperated micro gas turbine is challenged by the following factors:
Combustor pressure loss has to remain low. With the low compressor pressure ratio of recuperated micro turbines, pressure loss substantially penalizes the power output and efficiency. Typically, the relative burner pressure loss cannot exceed 2%.
Emission of undesirable chemicals has to be low, namely UHC, CO and NOx. CO and UHC can be effectively oxidized if flow temperature is maintained above 1500 C (˜1800 K). At these temperatures, NOx formation accelerates. However, NOx has to be maintained at single-digit ppm.
Stable and complete combustion has to be maintained along with low NOx at all operating points between base load and part load. At the same time, stable, complete and low NOx operation has to be guaranteed at light-off and during transients with both cold and hot recuperator.

### SUMMARY OF THE INVENTION

It is an object of the present invention to provide a combustor which is optimized for:
Operation in a recuperated micro gas turbine;
Low pressure loss;
Complete combustion and therefore low emission of CO and UHC;
Low emission of NOx;
Stable and low-emission operation at base load (with hot recuperator);
Stable and low-emission operation at part load;
Reliable light-off at cold conditions (with cold recuperator);
Reliable light-off at other conditions;
Stable and low-emission operation during transients;
Stable and low-emission operation at other conditions; and
Low cost.

To this end, the combustor according to the invention is characterized in that the relative position of the fuel injector and flame stabilization device in the burner is such that the burner stages first complete combustion of the fuel in the air through the air passages of the flame stabilization device where fuel is injected and then mixing with the air through the neighboring passages as such that NOx can never increase above single-digit ppm.

The fuel injector position relative to the flame stabilization device is chosen as to:
One hand, give the necessary residence time for the fuel to combust in the air through the air passages where fuel is injected; and
On the other hand, mix in the air through the neighboring passages before high NOx levels have been formed.

In the other words, the burner according to the invention stages first combustion of the fuel in the given part of the air and then mixing with the remaining air. In particular, combustion is complete and mixing occurs as such that NOx can never increase above single-digit ppm.

Preferably the fuel injector is present in the middle of the liner inlet opening, and the flame stabilization device is present in the inlet opening around the fuel injector and extends directly from the fuel injector to the boundary wall of the inlet opening.

An embodiment of the combustor according to the invention is characterized in that the flame stabilization device comprises two concentrically cylindrical rings and vanes extending in the radial direction from one ring to the other ring and being at an angle with the axial direction, wherein an air passage is present between two neighboring vanes of the flame stabilization device, and the geometry of the said rings, vanes and air passages result in a pressure loss over the flame stabilization device less than 1.5%.

This flame stabilization device has a swirl strength and air passage cross section as such that the pressure loss over the device is less than 1.5%. The pressure loss is dependent, among other parameters, on the geometry of the air passages, the flow rate and the flow density. The geometry of the air passages determines the swirl strength. Contrary to the common knowledge and experience, it has been established and confirmed experimentally that stable burning can be maintained in the combustor according to the invention even when the pressure loss is between 1% and 1.5%.

The flame stabilization device and the fuel injector form together with the liner inlet hardware a single burner, which guarantees both stable and complete combustion and low NOx at all operating regimes—steady state and transient. The same single burner guarantees reliable light-off at all conditions encountered in operation. This single burner is not assisted by any other burner.

A further embodiment of the combustor according to the invention is characterized in that the number of vanes in the flame stabilization device is such that only part of the air through the flame stabilization device can mix with fuel.

An air passage is present between each two neighboring vanes of the flame stabilization device. The fuel injector is provided with injection holes that inject fuel into a number of the air passages as such that the fuel is injected only in one passage from each set of two neighboring passages. Such fuel injection allows limited fuel-air mixing, where fuel is mixed with only part of the air. Due to this, the fuel-air mixture formed in the passages where fuel is injected is optimal for high stability of burning. However, high NOx levels can also form in the burned gases. Formation of high NOx levels is though prevented by quick mixing of these burned gases with the air that passes through the neighboring passages.

The invention further relates to a recuperated micro gas turbine comprising:
an air compressor having an air inlet and an air outlet;
a recuperator having an inlet and outlet for gases to be preheated and an inlet and outlet for hot gasses to be cooled, wherein the inlet for gases to be heated is connected to the outlet of the air compressor;
a combustor according to the invention described above having an air inlet and an outlet for burned gasses, wherein the inlet is being connected to the outlet of gasses heated in the recuperator;
a fuel delivery device (compressor in case of gaseous fuels and a pump in case of liquid fuels) connected to the combustor; and
a turbine having an inlet connected to the outlet of the combustor and an outlet connected to the inlet of the gasses to be cooled in the recuperator.

The invention further relates to a method for operating a gas turbine according to the invention, which is characterized in that the temperature of gases coming from the turbine is kept constant at the recuperator inlet. By this, the flame stabilization is improved at part-load operating points where the shaft power is less than at the base-load operating point. This improvement is realized by limiting reduction in the fuel-air ratio associated with modulation of the gas turbine from the base load to part load.

There is a great potential for employing micro gas turbines in an electrical power range from 1 kWe to 5 kWe. In particular, micro gas turbines are environmentally and cost effective for distributed power and/or heat and/or cooling generation in households, hotels, farms, restaurants, offices, etc., as well as for vehicular applications.

The recuperated micro gas turbine according to the invention can be for:
Electrical power generation systems.
The use in combined heat and electrical power systems, wherein the gas turbine drives an electrical generator to produce electrical power, and the heat in the gas turbine exhaust is—optionally—utilized for heating, such as space heating, water heating, etc. The heat can be also utilized to produce cooling.
The use in various heat and power systems in combination with other energy conversion devices, such as fuel cells, Rankine engines, etc.
The use in auxiliary systems in automotive, maritime and other vehicles.

### BRIEF DESCRIPTION OF THE DRAWINGS

The invention will be further elucidated below on the basis of drawings. These drawings show an embodiment of the combustor, combustor burner and recuperated micro gas turbine according to the invention. In the drawings:

FIG. 1 shows an embodiment of the recuperated micro gas turbine according to the invention;

FIG. 2 shows the combustor of the recuperated micro gas turbine;

FIG. 3 shows the flame stabilization device of the combustor;

FIG. 4 shows the fuel injector of the combustor; and

FIG. 5 shows a burner of the combustor in cross section composed of the flame stabilization device, fuel injector and liner inlet/head hardware.

### DETAILED DESCRIPTION OF THE DRAWINGS

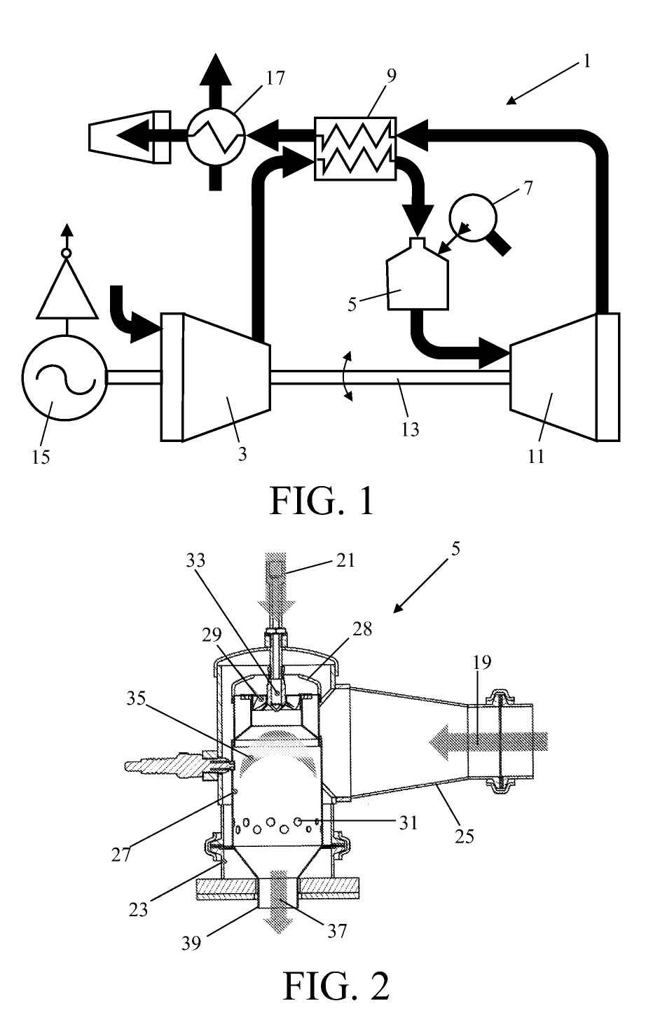

In FIG. 1, an embodiment of the recuperated micro gas turbine is shown according to the invention. The recuperated micro gas turbine 1 comprises an air compressor 3, a combustor 5, a fuel compressor 7 (for gaseous fuels) or pump (for liquid fuels), a recuperator 9 and a turbine 11. The turbine drives the air compressor via a shaft 13. The excess mechanical power produced by the turbine is converted into electrical power in a generator 15. The generator is either coupled to the turbine-compressor shaft or has its rotor mounted on the turbine-compressor shaft. After recuperator, the gases can be directed either to a gas-to-water heat exchanger 17 or other equipment for either heat or cooling production.

The combustor 5, see FIG. 2, typically receives air 19 compressed in the gas turbine air compressor and preheated in the recuperator. Fuel 21 to the combustor is delivered by either fuel compressor (for gaseous fuels) or fuel pump (for liquid fuels). The geometric envelope of the combustor is delimited by the casing 23. The air flow is diffused in the casing inlet diffuser 25 and dumped into the casing. Inside the casing, a liner 27 (or flame tube) is mounted. The inlet or head 28 of the liner is equipped with a flame stabilization device 29. The liner is also equipped with a system of air admission holes 31 and cooling arrangements. Combustion is staged inside the liner. The air flow is divided between the flame stabilization device 29, cooling arrangement and air admission holes 31. The fuel injector 33 is usually located in the vicinity of the flame stabilization device 29. The air flow through the flame stabilization device is usually the combustion air. Fuel is injected and mixed with this air. The flame stabilization device 29, fuel injector 33 and liner inlet/head hardware 28 are commonly referred to as burner. The flame 35 is stabilized downstream the fuel stabilization device 29. After combustion has been either fully or essentially completed, the air through the air admission holes 31 is mixed with the products of combustion. This air is called dilution air. Cooling air is gradually mixed with the gases. Diluted gases 37 are directed into the turbine at the combustor outlet 39.

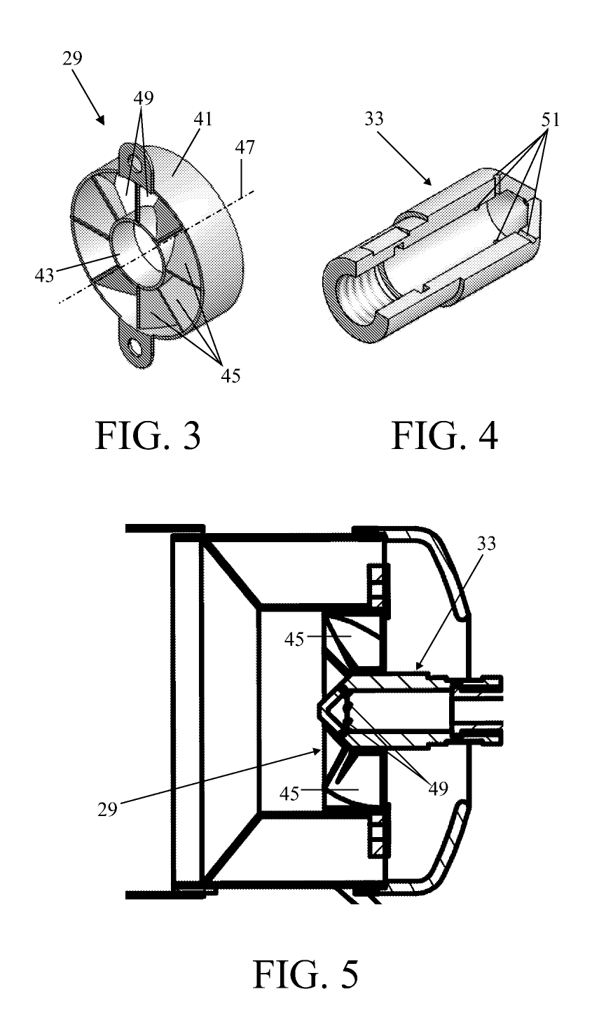

In FIG. 3, the flame stabilization device 29 is shown. The flame stabilization device comprises two concentrically cylindrical rings 41 and 43 and a number of vanes 45 extending in radial direction from one ring to the other ring and being at an angle with the axial direction 47. Air passages 49 are present between the vanes.

In FIG. 4, the fuel injector 33 of the combustor is shown. The fuel injector comprises a number of injection holes 51 over the circumference of the injector such that fuel is only injected into half the number of air passages in the flame stabilization device, whereby fuel is injected alternately in one passage and no fuel is injected in the next passage.

In FIG. 5, a cross section of the burner composed of the flame stabilization device, fuel injector and liner head hardware is shown. The position of the fuel injector 33 relative to the flame stabilization device 29 is chosen for optimal limited fuel-air mixing. It allows the burner to stage first complete combustion of the fuel in the given part of the air and then mixing with the remaining air as such that NOx can never increase above single-digit ppm.

Although the present invention is elucidated above on the basis of the given drawings, it should be noted that this invention is not limited whatsoever to the embodiments shown in the drawings. The invention also extends to all embodiments deviating from the embodiments shown in the drawings within the context defined by the claims.

1. A combustor comprising:
a casing having a cylindrical wall provided with an opening for compressed air;
a liner being within said casing and having a further cylindrical wall at a distance from the casing wall, an outlet opening on one end and an inlet opening on the other end; and
one single burner comprising a fuel injector to inject fuel into the liner and a flame stabilization device comprising air passages,
wherein the relative position of the fuel injector and flame stabilization device in the burner is such that the burner stages first complete combustion of the fuel in the air through the air passages of the flame stabilization device where fuel is injected and then mixing with the air through the neighboring passages as such that NOx can never increase above single-digit ppm.

2. The combustor according to claim 1, wherein the fuel injector is present in the middle of the liner inlet opening, and the flame stabilization device is present in the inlet opening around the fuel injector and extends directly from the fuel injector to the boundary wall of the inlet opening.

3. The combustor according to claim 2, wherein the flame stabilization device comprises two concentrically cylindrical rings and vanes extending in the radial direction from one ring to the other ring and being at an angle with the axial direction, wherein an air passage is present between two neighboring vanes of the flame stabilization device, and the geometry of the said rings, vanes and air passages result in a pressure loss over the flame stabilization device less than 1.5%.

4. The combustor according to claim 3, wherein the fuel injector is provided with injection holes which during operation inject fuel into the airflow through a part of the total number of the air passages.

5. The combustor according to claim 4, wherein the injection holes are arranged over the circumference of the fuel injector such that fuel is only injected into half the number of air passages in the flame stabilization device.

6. A recuperated micro gas turbine comprising:
an air compressor having an air inlet and an air outlet;
a recuperator having an inlet and outlet for gases to be preheated and an inlet and outlet for hot gasses to be cooled, wherein the inlet for gases to be heated is connected to the outlet of the air compressor;
a combustor according to one of the previous claims having an air inlet and an outlet for burned gasses, wherein the inlet is connected to the outlet of gasses heated in the recuperator;
a fuel delivery device connected to the combustor; and
a turbine having an inlet connected to the outlet of the combustor and an outlet connected to the inlet of the gasses to be cooled of the recuperator.

7. The combustor according to claim 1, wherein the burner is a single and non-assisted burner for complete combustion, single-digit ppm NOx and reliable light-off under all operating conditions.

8. A method for operating a recuperated gas turbine, the method comprising the steps of:
providing a recuperated micro gas turbine comprising:
an air compressor having an air inlet and an air outlet;
a recuperator having an inlet and outlet for gases to be preheated and an inlet and outlet for hot gasses to be cooled, wherein the inlet for gases to be heated is connected to the outlet of the air compressor;
a combustor according to one of the previous claims having an air inlet and an outlet for burned gasses, wherein the inlet is connected to the outlet of gasses heated in the recuperator,
a fuel delivery device connected to the combustor; and
a turbine having an inlet connected to the outlet of the combustor and an outlet connected to the inlet of the gasses to be cooled of the recuperator;
operating the micro gas turbine, wherein the temperature of gases coming from the turbine is kept constant at the recuperator inlet.
